(19) United States
(12) Patent Application Publication
(10) Pub. No.: US 2012/0045072 A1
(43) Pub. Date: Feb. 23, 2012

(54) REAR SEAT ENTERTAINMENT SYSTEM

(76) Inventors: Shigenobu Matsuda, Tokyo (JP); Takafumi Yamamoto, Tokyo (JP)

(21) Appl. No.: 13/254,494

(22) PCT Filed: Mar. 12, 2010
(86) PCT No.: PCT/JP2010/001787

§ 371 Date: Sep. 2, 2011

(30) Foreign Application Priority Data
May 26, 2009 (JP) 2009-126613

(51) Int. Cl. H04R 1/02

(52) U.S. Cl. 381/86

(57) ABSTRACT

A rear seat entertainment system (RSE) is composed of a display unit (LCD monitor 2) mounted openably and closably about a hinge 20; a sound waveguide-type speaker unit that is mounted in a position that does not obstruct the opening and closing of the display unit, and that has a slit-shaped opening 3 (3a, 3b) aimed at a listener; and a controlling device (RSE main body 1) including an arithmetic processing unit 23 that has a filter coefficient of an inverse correction filter, based on the previously measured acoustic characteristics of the sound waveguide-type speaker unit 5 (5a, 5b), and that corrects the phase characteristics and the sound pressure frequency characteristics of the sound waveguide-type speaker unit by the inverse correction filter.

### TECHNICAL FIELD

The present invention relates to a speaker integrated rear seat entertainment system to be installed on the ceiling of a motor vehicle.

### BACKGROUND ART

Vehicle-mounted information equipment can cover various kinds of videos and audios of high entertainment to increase the comfort of an occupant in a vehicle, and the installation of two or more AV (Audio Visual) systems for reproducing the videos and audios in the vehicle is on its way to becoming popular.

For example, in a comparatively large vehicle having three rows of seats, a ceiling mounting type rear monitor is often installed on the ceiling of a vehicle through a bracket for the second and the third row rear seats thereof. On this account, in a rear seat entertainment system (hereinafter, referred to simply as an “RSE”) that enables by a front seat the control of a sound source to be reproduced in the rear seats, a head unit and a rear control unit are provided in the front seats and the rear seats, respectively; in the rear seats, it is possible to freely see or listen to contents that are different from those of the front seats by way of the rear control unit with the ceiling mounting type rear monitor. However, the listening of the sound source is performed in most cases through a wireless headphone or a vehicle-mounted speaker to be driven in synchronization with the head unit.

On that account, a speaker integrated rear monitor is conventionally known, which enables occupants in front and rear seats to freely enjoy listening to different contents from each other (for example, see Patent Document 1).

On the other hand, conventionally, in the field of television, in order to prevent an acoustic signal emitted from the opening of a sound waveguide in a sound waveguide-type speaker unit from being deteriorated as compared with the characteristics inherent in a speaker itself under the influence of the sound waveguide, a sound-reproducing apparatus is known to perform sound signal processing by using a non-recursive digital filter achieving an inverse characteristic to the transfer characteristic of the sound waveguide (hereinafter, referred to as “linear phase correction technique”) (for example, see Patent Document 2).

### PRIOR ART DOCUMENTS

### Patent Documents

Patent Document 1: JP-A-2006-248253

Patent Document 2: Japanese Patent No. 3167259

### SUMMARY OF THE INVENTION

### Problem to be Solved by the Invention

In the above-discussed typical RSE, since the listening of a sound source is performed by way of a wireless headphone, the wireless headphone has to be attached to the RSE, resulting in a comparatively expensive system. Further, there is also a problem such that the wireless headphone is not adjustable in size for a small child to be not attached thereto.

Meanwhile, when a speaker is integrated into the RSE like the technique disclosed by Patent Document 1, a large-diameter speaker cannot be mounted thereon because of the constraints in size of the RSE; thus, there is a problem in bass reproduction. Further, a round speaker cannot be mounted thereon because of the constraints in design of the RSE, and an elliptical speaker is mounted thereon in most cases; thus, distortion occurs in sound to deteriorate the sound quality. Therefore, there has been demanded the correction to the deterioration in the sound quality by applying thereto the linear phase correction technique disclosed in Patent Document 2.

The present invention has been made to solve the above-discussed problems, and an object of the present invention is to provide a rear seat entertainment system that can avoid the deterioration in the sound quality without damaging the compact feeling of the RSE by using the linear phase correction technique.

### Means for Solving Problem

In order to solve the aforementioned problems, a rear seat entertainment system according to the present invention includes a display unit mounted openably and closably about a hinge; a sound waveguide-type speaker unit that is mounted in a position that does not obstruct the opening and closing of the display unit and that has a slit-shaped opening aimed at a listener; and a controlling device including an arithmetic processing unit that has a filter coefficient of an inverse correction filter, based on the previously measured acoustic characteristics of the sound waveguide-type speaker unit, and that corrects the phase characteristics and the sound pressure frequency characteristics of the sound waveguide-type speaker unit by the inverse correction filter.

### Effect of the Invention

According to the present invention, by using a linear phase correction technique, it is possible to provide a rear seat entertainment system avoiding the degradation in sound quality without deteriorating the compact feeling of the RSE.

### BRIEF DESCRIPTION OF THE DRAWINGS

FIG. 1 is a perspective view showing an appearance of a rear seat entertainment system in accordance with a first embodiment of the present invention.

FIG. 2 is a sectional view of the rear seat entertainment system in accordance with the first embodiment of the invention.

FIG. 3 is a front view of the rear seat entertainment system in accordance with the first embodiment of the invention as is viewed from a rear seat.

FIG. 4 is a block diagram showing an internal configuration of an electrical system of the rear seat entertainment system in accordance with the first embodiment of the invention.

FIG. 5 is a sectional view of a rear seat entertainment system in accordance with a second embodiment of the invention.

FIG. 6 is a front view of the rear seat entertainment system in accordance with the second embodiment of the invention as is viewed from a rear seat.

FIG. 7 is a sectional view of a rear seat entertainment system in accordance with a third embodiment of the invention.

FIG. 8 is a front view of the rear seat entertainment system in accordance with the third embodiment of the invention as is viewed from a rear seat.

### BEST MODE FOR CARRYING OUT THE INVENTION

Embodiments of the present invention will now be described with reference to the accompanying drawings in order to explain the present invention in more detail.

### First Embodiment

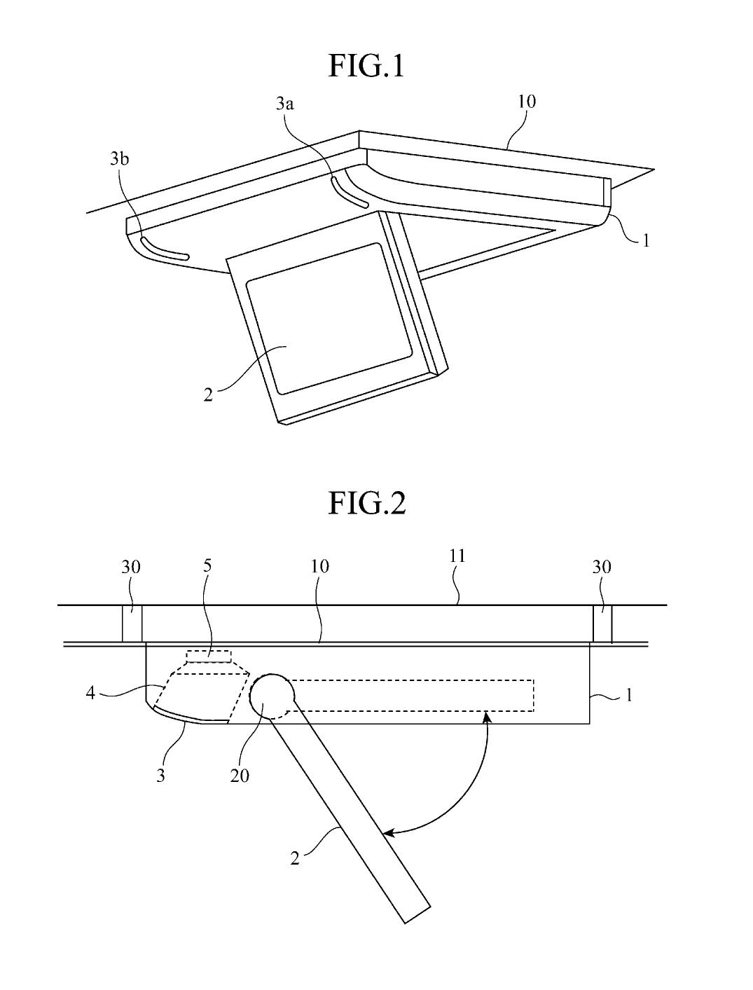

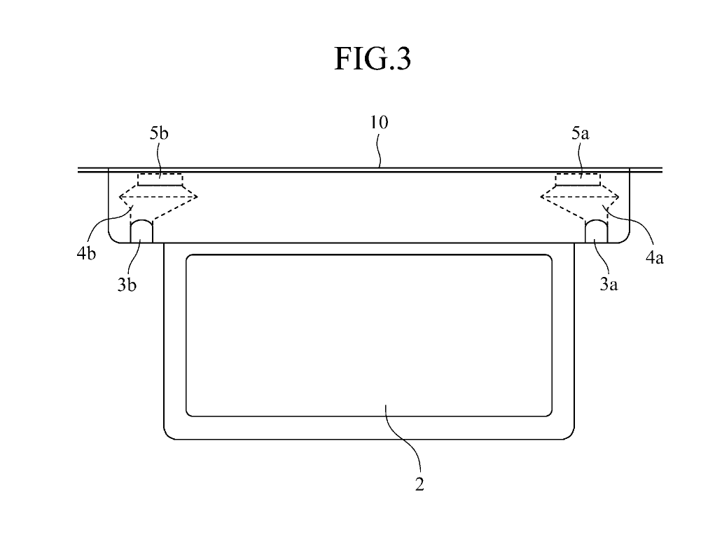

FIG. 1 is a perspective view of a rear seat entertainment system in accordance with a first embodiment of the present invention, FIG. 2 is a sectional view thereof, and FIG. 3 is a front view thereof as is viewed from a rear seat.

In FIG. 1 to FIG. 3, reference numeral 1 represents an RSE main body; a liquid crystal (LCD: Liquid Crystal Display Device) monitor 2 that is a display unit for displaying images and a sound waveguide-type speaker unit 5 (5a ,5b) for outputting sounds are mounted thereon. Reference numeral 3 (3a, 3b) represents an opening, formed in a slit, for transmitting the sounds outputted by the sound waveguide-type speaker unit 5 (5a, 5b) to a rear seat occupant. Reference numeral 10 represents a vehicle ceiling given a liner, and the RSE main body 1 is attached to the vehicle ceiling 10 through a bracket 30.

The LCD monitor 2 is configured openably and closably about a hinge 20 in the RSE main body 1; the monitor is opened in its use position to be placed in a state where the monitor is seen by a rear seat occupant, and is closed in its non-use position to be housed in the RSE main body 1, thus rendering a structure protecting the LCD monitor surface.

The sound waveguide-type speaker unit 5 (5a, 5b) includes a sound waveguide 4 (4a, 4b) for guiding the sound outputted from the main body of the speaker to the opening 3 (3a, 3b), and the speaker unit is mounted in a position which does not obstruct the opening and closing of the LCD monitor 2. Additionally, reference numeral 11 represents a vehicle roof panel; a space is typically provided between the roof panel 11 and the vehicle ceiling 10.

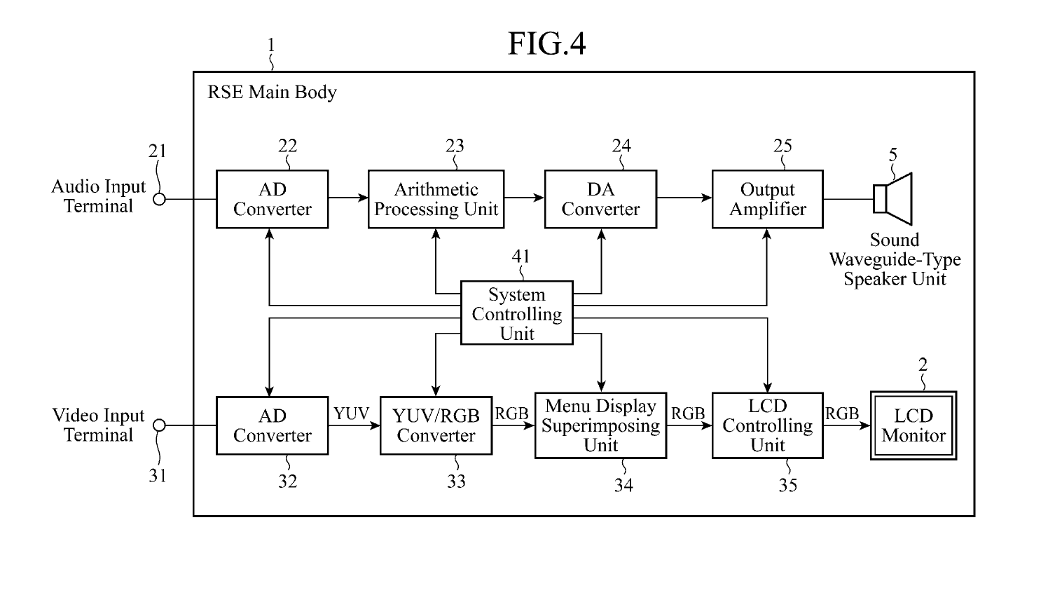

FIG. 4 is a block diagram showing an internal configuration of an electrical system of the rear seat entertainment system in accordance with the first embodiment of the present invention.

As shown in FIG. 4, the RSE main body (controlling device) 1 includes an audio input terminal 21, an analogue/digital converter (AD converter) 22, an arithmetic processing unit 23, a digital/analog converter (DA converter) 24, and an output amplifier 25. The RSE main body 1 further includes a video input terminal 31, an AD converter 32, a YUV (luminance and color-difference signal)/RGB (primary color signal) converter 33, a menu display superimposing unit 34, and an LCD controlling unit 35. Furthermore, the RSE main body is configured by including a system controlling unit 41 for performing sequential control on these components.

Hereupon, in FIG. 4, the blocks designated by the same numerals as those of FIG. 1 to FIG. 3 is to have the same names and functions as those shown in FIG. 1 to FIG. 3.

The audio input terminal 21 outputs the analog audio signal outputted from an audio reproduction source (not shown) to the AD converter 22. The AD converter 22 converts the inputted analog audio signal into a digital audio signal to output the signal to the arithmetic processing unit 23.

The arithmetic processing unit 23 performs volume control, adjusts the balance between right and left volumes on the digital audio signal, and performs correction processing for degradation in sound quality by using a linear phase correction technique to output the signal to the DA converter 24.

The DA converter 24 converts the digital audio signal outputted from the arithmetic processing unit 23 into an analog audio signal to output the resultant signal to the output amplifier 25. The output amplifier 25 amplifies the signal level of the analog audio signal outputted from the DA converter 24 to supply the resultant signal to the sound waveguide-type speaker unit 5 and output the signal as a sound.

The video input terminal 31 outputs the analog video signal outputted from a reproduction source (not shown) to the AD converter 32. The AD converter 32 converts the analog video signal (composite signal) inputted from the video input terminal 31 into a digital YUV signal to output the resultant signal to the YUV/RGB converter 33.

The YUV/RGB converter 33 converts the digital YUV signal into a digital RGB signal to output the signal to the menu display superimposing unit 34. The menu display superimposing unit 34 superimposes a user operation menu or the like on the video signal outputted by the YUV/RGB converter 33 to output the signal to the LCD controlling unit 35. The LCD controlling unit 35 controls an output timing or the like in order to display the video signal outputted from the menu display superimposing unit 34 on the LCD monitor 2.

It is to be noted that in order to control the RSE main body 1, the system controlling unit 41 performs the sequential control of the AD converter 22, the arithmetic processing unit 23, the DA converter 24, the output amplifier 25, the AD converter 32, the YUV/RGB converter 33, the menu display superimposing unit 34, and the LCD controlling unit 35, as discussed above.

In the aforementioned configuration, an analog video signal inputted from external devices such as a DVD player or the like is inputted to the RSE main body 1 via the video input terminal 31.

Hereupon, the inputted analog video signal is converted into video data of a digital YUV format by the AD converter 32. Thereafter, the signal is converted into video data of a digital RGB format by the YUV/RGB converter 33, and outputted to the menu display superimposing unit 34. The menu display superimposing unit 34 superimposes a user operation menu on the video signal inputted from the external devices as the need arises. The video signal having a user operation menu superimposed thereon is adjusted about the output timing of the video signal or the like by the LCD controlling unit 35, and is displayed on the LCD monitor 2.

On the other hand, the analog audio signal inputted from the external devices is inputted to the RSE main body 1 via the audio input terminal 21. The analog audio signal inputted therethrough is converted into data of a digital PCM (Pulse Code Modulation) format by the AD converter 22, and inputted to the arithmetic processing unit 23.

The arithmetic processing unit 23 performs volume control and adjusts the balance between right and left volumes on the inputted audio signal of the digital PCM format, and performs linear phase correction processing for preventing degradation in sound quality thereof.

However, in the case where the arithmetic processing unit 23 executes the above-discussed linear phase correction processing, it is necessary to complete previously the measurement of the acoustic characteristics of the sound waveguide-type speaker unit 5 (5a, 5b) based on an impulse response. The filter coefficient of an inverse correction filter (digital filter) is determined based on the measurement results in this case, and a convolution operation is performed on the input audio signal by using the inverse correction filter designed here, to thereby correct the phase characteristics and the sound pressure frequency characteristics of the sound waveguide-type speaker unit 5 (5a, 5b). The linear phase technology is disclosed in more detail in Patent Document 2 discussed above. In this connection, the arithmetic processing unit 23 having the above-discussed inverse correction filter installed therein is to be composed of a DSP (Digital Signal Processor).

The audio signal subjected to the signal processing in accordance with the above descriptions is converted into an analog audio signal by the DA converter 24, further subjected to amplification at a signal level by the output amplifier 25, and then outputted to the sound waveguide-type speaker unit 5 (5a , 5b).

Hereupon, it is assumed that the system controlling unit 41 controls the whole RSE main body 1 and also controls a user interface.

Incidentally, as shown in FIG. 2, the RSE main body 1 is attached to the vehicle ceiling 10 through the bracket 30. Further, the sound waveguide-type speaker unit 5 (5a, 5b) is mounted to the inside of the RSE main body 1.

The audio signal outputted from the sound waveguide-type speaker unit 5 (5a, 5b) passes through the slit of the opening 3 (3a, 3b) via the sound waveguide 4 (4a, 4b), and reaches an occupant in a rear seat. The sound waveguide 4 (4a, 4b) is mounted thereon to be inclined to the rear seat, and arranged to have sound directivity to the rear seat.

Moreover, as shown in FIG. 3, the lateral width of each of the right and the left openings 3a, 3b of the sound waveguide-type speaker unit 5 (5a, 5b) is shorter than the diameter of the speaker main body of the sound waveguide-type speaker unit 5 (5a, 5b), under the design constraint that the lateral width of the RSE main body 1 is to be shortened. Therefore, the right and left sound waveguides 4a, 4b each have an inversed-horn shape which gradually narrows towards the respective openings 3a, 3b from the speaker main body of the sound waveguide-type speaker unit 5 (5a, 5b); under such conditions, the sound will be muffled by the sound waveguide 4 (4a, 4b).

On that account, the arithmetic processing unit 23 executes linear phase correction processing as disclosed in Patent Document 2, corrects the degradation in sound quality caused by the sound waveguide 4 (4a, 4b), and also improves the deterioration in sound quality to be caused by the design constraint.

According to the rear seat entertainment system of the first embodiment discussed above, the sound waveguide-type speaker unit 5 (5a, 5b) having the opening 3 (3a, 3b) shaped like a slit aimed at a listener is mounted in a position which does not obstruct the opening and closing of the LCD monitor 2, and the electric system of the RSE main body 1 (arithmetic processing unit 23) corrects the phase characteristics and the sound pressure frequency characteristics of the sound waveguide-type speaker unit 5 (5a, 5b) with the filter coefficient of the inverse correction filter, based on the previously measured acoustic characteristics of the sound waveguide-type speaker unit 5 (5a, 5b). In other words, when a linear phase correction technique is applied to the RSE, the structural factors causing the deterioration in sound quality can be improved, including the deficiency in performance of the sound waveguide-type speaker unit 5 (5a, 5b) used therein.

Moreover, according to the rear seat entertainment system of the first embodiment, the sound waveguide-type speaker unit 5 (5a, 5b) is integrated into the RSE main body 1 to thereby allow the listening without using a wireless headphone, thus eliminating the necessity for an expensive headphone and enabling the listening without degradation in sound.

Furthermore, formation of the opening 3 (3a, 3b) in the shape of a slit does not reduce a compact feeling of the RSE, and application of a linear phase technology thereto enables the correction of the sound quality.

### Second Embodiment

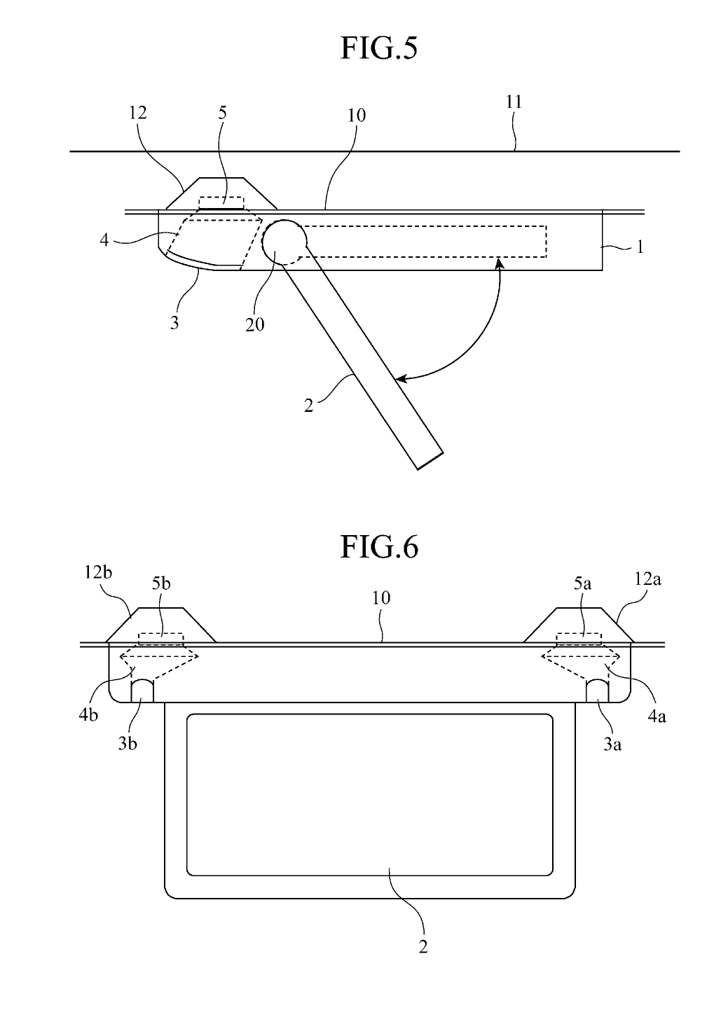

FIG. 5 is a sectional view of a rear seat entertainment system in accordance with a second embodiment of the present invention, and FIG. 6 is a front view thereof as is viewed from a rear seat.

As shown in FIG. 5 and FIG. 6, a distinction of the second embodiment to the first embodiment shown in FIG. 1 to FIG. 3 is as follows: there is provided a structure where a sound waveguide-type speaker unit 5 (5a, 5b) is installed through the vehicle ceiling 10, and further the back of the sound waveguide-type speaker unit 5 (5a, 5b) is covered with a cover frame 12 (12a, 12b). The other arrangements are similar to those of the first embodiment shown in FIG. 1 to FIG. 3, and the configuration of the electric system is also similar thereto.

When sound is outputted from a common speaker, the sound outputted from the back of the speaker is reversed in phase with that outputted from the front of the speaker, and thus, if the sound outputted from the back goes around to the front thereof, the two sounds balance each other out, which prevents the output of an original sound. A similar phenomenon may also occur in the sound waveguide-type speaker unit 5 (5a, 5b).

Therefore, in the second embodiment, as shown in FIG. 5 and FIG. 6, in order to prevent the sound outputted from the back of a speaker from interfering with the sound outputted from the front thereof, it is schemed that the sound waveguide-type speaker unit 5 (5a, 5b) have the back thereof sealed with the cover frame 12 (12a, 12b). Under this condition, according as the space of the back is set as large as possible, the bass sound can be reproduced effectively.

In this connection, the arithmetic processing unit 23 performs linear phase correction processing to thereby correct the degradation in sound quality to be caused by the sound waveguide 4 (4a, 4b) of the sound waveguide-type speaker unit 5 (5a, 5b) and also prevent the sound quality from being deteriorated by design constraints as in the first embodiment.

According to the rear seat entertainment system of the second embodiment, it is arranged that the sound waveguide-type speaker unit 5 (5a, 5b) is installed on the top of the vehicle ceiling 10, and that also the back of the sound waveguide-type speaker unit 5 (5a, 5b) is covered with the cover frame 12 (12a, 12b); thereby, the reproduction of bass sound becomes possible, and further the RSE main body 1 can be reduced in thickness by the outward extension of the sound waveguide-type speaker unit 5 (5a, 5b) from the RSE main body 1.

In this connection, in the above-discussed first embodiment, the sound waveguide-type speaker unit 5 (5a, 5b) is mounted to the inside of the RSE main body 1 as shown in FIG. 2, the speaker cannot have a large space on the back thereof; therefore, the arrangement suffers from a disadvantage in the reproduction of bass sound. However, in the above-discussed second embodiment, as shown in FIG. 5, the sound waveguide-type speaker unit 5 (5a, 5b) is installed on the top of the vehicle ceiling 10, and further a space is provided between the ceiling and the cover frame 12 (12a, 12b) covering the back of the sound waveguide-type speaker unit 5 (5a, 5b) within the range permitted by a gap provided between the cover frame and the vehicle roof panel 11. Thereby, the bass reproduction in which a feeling of insufficient sound pressure could not be denied can be attained.

Further, when the sound waveguide-type speaker unit 5 (5a, 5b) is extended upwardly from the RSE main body 1, it becomes possible to reduce the thickness of the RSE main body 1.

### Third Embodiment

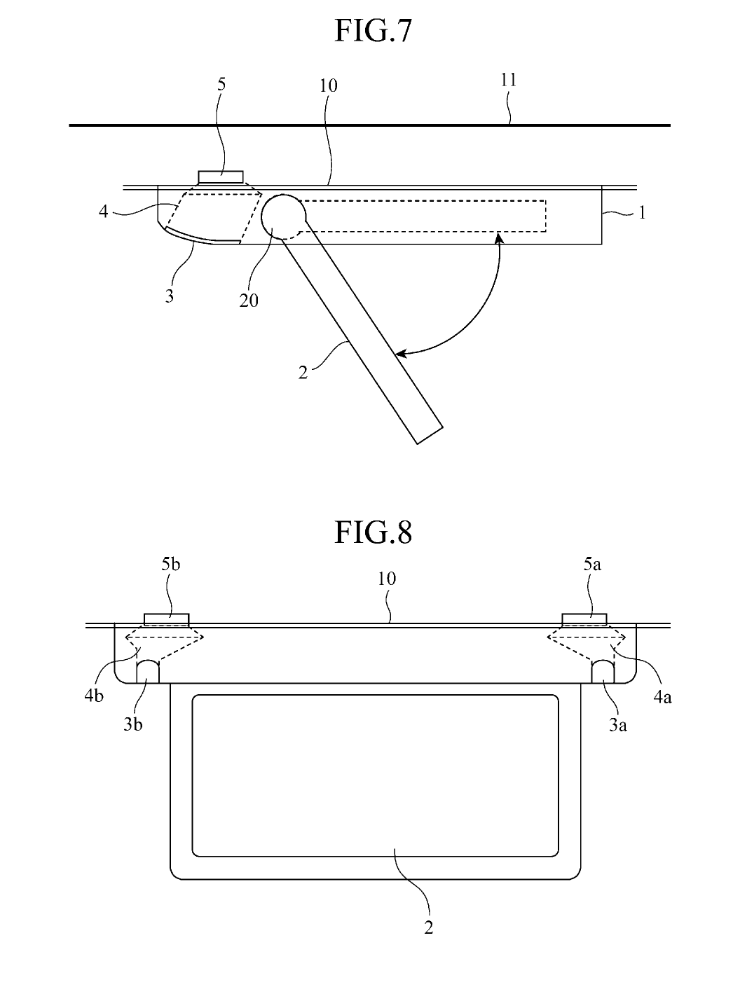

FIG. 7 is a sectional view of a rear seat entertainment system in accordance with a third embodiment of the present invention, and FIG. 8 is a front view thereof as is viewed from a rear seat.

As shown in FIG. 7 and FIG. 8, a distinction of the third embodiment to the second embodiment shown in FIG. 5 and FIG. 6 is as follows: there is provided a planar baffle structure where a sound waveguide-type speaker unit 5 (5a, 5b) uses a space between the vehicle ceiling 10 and the vehicle roof panel 11. The other arrangements are similar to those of the second embodiment.

In the above-discussed speaker mounting structure, the cover frame 12 (12a, 12b) discussed in the second embodiment is removed, a space between the vehicle ceiling 10 and the vehicle roof panel 11 is used as a space for the back of the sound waveguide-type speaker unit 5 (5a, 5b). Thereby, a comparatively large space can be allocated, which enables to reproduce the bass sound more powerful as compared with the second embodiment discussed above.

It is to be noted that the sound waveguide-type speaker unit 5 (5a, 5b) is detached from the RSE main body 1 to be installed on the top of the vehicle ceiling 10, and the arithmetic processing unit 23 performs linear phase correction processing to thereby correct the degradation in sound quality to be caused by the sound waveguide 4 (4a, 4b) and also prevent the sound quality from being deteriorated due to design constraints as in the second embodiment.

According to the rear seat entertainment system of the above-discussed third embodiment, the sound waveguide-type speaker unit 5 (5a, 5b) is installed on the top of the vehicle ceiling 10 to form a planar baffle structure using a space between the vehicle ceiling 10 and the vehicle roof panel 11; thereby, the sound quality degradation can be prevented by the linear phase correction technique as a matter of course, and further insufficient sound pressure in bass sound can be compensated still better as compared with the second embodiment.

Additionally, all the functions of the arithmetic processing unit 23 shown in FIG. 4 can be achieved by software, and alternatively, at least part of the functions can be performed by hardware.

For example, the data processing where the arithmetic processing unit 23 corrects the phase characteristics and the sound pressure frequency characteristics of the sound waveguide-type speaker unit 5 (5a, 5b) with the inverse correction filter of which the filter coefficient is set based on the previously measured acoustic characteristics of the sound waveguide-type speaker unit 5 (5a, 5b) may be performed on a computer with one or a plurality of programs, or at least part of the processing may be also executed by hardware.

### INDUSTRIAL APPLICABILITY

The rear seat entertainment system according to the present invention can avoid the deterioration in sound quality by using a linear phase correction technique without damaging a compact feeling of the RSE; thus, it is suitable for use in a speaker integrated rear seat entertainment system and so on to be attached to the vehicle ceiling.

1. A rear seat entertainment system comprising:
a display unit mounted closably and openably about a hinge;
a sound waveguide-type speaker unit that is mounted in a position that does not obstruct the opening and closing of the display unit, and that has an opening aimed at a listener; and
a controlling device including an arithmetic processing unit that has a filter coefficient of an inverse correction filter, based on the previously measured acoustic characteristics of the sound waveguide-type speaker unit, and that corrects the phase characteristics and the sound pressure frequency characteristics of the sound waveguide-type speaker unit by the inverse correction filter.

2. The rear seat entertainment system according to claim 1, wherein the opening has the shape of a slit.

3. The rear seat entertainment system according to claim 1, wherein the sound waveguide-type speaker unit is installed on the top of a vehicle ceiling, and wherein the back of the sound waveguide-type speaker unit is covered with a cover frame.

4. The rear seat entertainment system according to claim 1, wherein the sound waveguide-type speaker unit is installed on the top of a vehicle ceiling, and has a planar baffle structure using a space between the vehicle ceiling and a vehicle roof panel.
